(19) United States
(12) Patent Application Publication
(10) Pub. No.: US 2008/0138604 A1
(43) Pub. Date: Jun. 12, 2008

(54) AUTHENTICATING AND IDENTIFYING OBJECTS USING MARKINGS FORMED WITH CORRELATED RANDOM PATTERNS

(76) Inventors: John Kenney, Palo Alto, CA (US); William M. Pfenninger, Fremont, CA (US)

Correspondence Address: COOLEY GODWARD KRONISH LLP;ATTN: Patent Group, Suite 1100, 777 - 6th Street, NW, Washington, DC, 20001, US

(21) Appl. No.: 11/743,513

(22) Filed: May 2, 2007

Related U.S. Application Data
(60) Provisional application No. 60/797,189, filed on May 2, 2006.

(51) Int. Cl. C09K 11/00

(52) U.S. Cl. 428/323

(57) ABSTRACT

Described herein are techniques for authenticating and identifying objects using markings formed with correlated random patterns. In one embodiment, an object to be authenticated includes a substrate and a marking adjacent to the substrate. The marking includes a luminescent material distributed in accordance with a correlated random pattern, and the luminescent material exhibits photoluminescence having a quantum efficiency of at least 10 percent.

### CROSS-REFERENCE TO RELATED APPLICATION

This application claims the benefit of U.S. Provisional Application Ser. No. 60/797,189, filed on May 2, 2006, the disclosure of which is incorporated herein by reference in its entirety.

### FIELD OF THE INVENTION

The invention relates generally to authenticating and identifying objects. More particularly, the invention relates to authenticating and identifying objects using markings formed with correlated random patterns.

### BACKGROUND OF THE INVENTION

An object to be authenticated or identified is sometimes provided with a specific marking, which can be part of the object itself or can be coupled to the object. For example, a commonly used marking is a bar code, which includes a linear array of elements that are either printed directly on an object or on labels that are coupled to the object. These elements typically include bars and spaces, with bars of varying widths representing strings of binary ones, and spaces of varying widths representing strings of binary zeros. While bar codes are useful for tracking locations or identities of objects, these markings can be readily reproduced and, thus, have limited effectiveness in terms of preventing counterfeiting.

It is against this background that a need arose to develop the apparatus, system, and method described herein.

### SUMMARY OF THE INVENTION

In one aspect, the invention relates to an object to be authenticated. In one embodiment, the object includes a substrate and a marking, adjacent to the substrate. The marking includes a luminescent material distributed in accordance with a correlated random pattern, and the luminescent material exhibits photoluminescence having a quantum efficiency of at least 10 percent.

Other aspects and embodiments of the invention are also contemplated. The foregoing summary and the following detailed description are not meant to restrict the invention to any particular embodiment but are merely meant to describe various embodiments of the invention.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates a security system that is implemented in accordance with an embodiment of the invention.

FIG. 2 provides a line drawing replicating an image of a marking, according to an embodiment of the invention.

FIG. 3 illustrates a two-dimensional array formed via Penrose tiling, according to an embodiment of the invention.

### DETAILED DESCRIPTION

### Definitions

The following definitions apply to some of the elements described with regard to some embodiments of the invention. These definitions may likewise be expanded upon herein.

As used herein, the singular terms “a,” “an,” and “the” include plural referents unless the context clearly dictates otherwise. Thus, for example, reference to an object can include multiple objects unless the context clearly dictates otherwise.

As used herein, the term “set” refers to a collection of one or more elements. Thus, for example, a set of objects can include a single object or multiple objects. Elements of a set can also be referred to as members of the set. Elements of a set can be the same or different. In some instances, elements of a set can share one or more common characteristics.

As used herein, the terms “optional” and “optionally” mean that the subsequently described event or circumstance may or may not occur and that the description includes instances where the event or circumstance occurs and instances in which it does not.

As used herein, the term “adjacent” refers to being near or adjoining. Objects that are adjacent can be spaced apart from one another or can be in actual or direct contact with one another. In some instances, objects that are adjacent can be coupled to one another or can be formed integrally with one another.

As used herein, the term “ultraviolet range” refers to a range of wavelengths from about 5 nanometer (“nm”) to about 400 nm.

As used herein, the term “visible range” refers to a range of wavelengths from about 400 nm to about 700 nm.

As used herein, the term “infrared range” refers to a range of wavelengths from about 700 nm to about 2 millimeter (“mm”). The infrared range includes the “near infrared range,” which refers to a range of wavelengths from about 700 nm to about 5 micrometer (“μm”), the “middle infrared range,” which refers to a range of wavelengths from about 5 μm to about 30 μm, and the “far infrared range,” which refers to a range of wavelengths from about 30 μm to about 2 mm.

As used herein, the terms “refraction,” “refract,” and “refractive” refer to a delaying of a phase front of light. Refraction can occur when light passes through an interface between materials having different indices of refraction.

As used herein, the terms “luminescence,” “luminesce,” and “luminescent” refer to an emission of light in response to an energy excitation. Luminescence can occur based on relaxation from excited electronic states of atoms or molecules and can include, for example, chemiluminescence, electroluminescence, photoluminescence, thermoluminescence, triboluminescence, and combinations thereof. For example, in the case of electroluminescence, an excited electronic state can be produced based on an electrical excitation. In the case of photoluminescence, which can include fluorescence and phosphorescence, an excited electronic state can be produced based on an optical excitation, such as absorption of light. In general, light incident upon a material and light emitted by the material can have wavelengths that are the same or different.

As used herein with respect to photoluminescence, the term “quantum efficiency” refers to a ratio of the number of photons emitted by a material to the number of photons absorbed by the material. In some instances, a quantum efficiency can be described with reference to a specific range of wavelengths of light incident upon a material or a specific range of wavelengths of light emitted by the material.

As used herein, the term “absorption spectrum” refers to a representation of absorption of light over a range of wavelengths. In some instances, an absorption spectrum can refer to a plot of absorbance (or transmittance) of a material as a function of wavelength of light incident upon the material.

As used herein, the term “emission spectrum” refers to a representation of emission of light over a range of wavelengths. In some instances, an emission spectrum can refer to a plot of intensity of light emitted by a material as a function of wavelength of the emitted light.

As used herein, the term “excitation spectrum” refers to another representation of emission of light over a range of wavelengths. In some instances, an excitation spectrum can refer to a plot of intensity of light emitted by a material as a function of wavelength of light incident upon the material.

As used herein, the term “Full Width at Half Maximum” or “FWHM” refers to a measure of spectral width. In the case of an emission spectrum, a FWHM can refer to a width of the emission spectrum at half of a peak intensity value.

As used herein, the term “sub-nanometer range” or “sub-nm range” refers to a range of dimensions less than about 1 nm, such as from about 0.1 nm to slightly less than about 1 nm.

As used herein, the term “nanometer range” or “nm range” refers to a range of dimensions from about 1 nm to about 1 μm. The nm range includes the “lower nm range”, which refers to a range of dimensions from about 1 nm to about 10 nm, the “middle nm range,” which refers to a range of dimensions from about 10 nm to about 100 nm, and the “upper nm range,” which refers to a range of dimensions from about 100 nm to about 1 μm.

As used herein, the term “micrometer range” or “μm range” refers to a range of dimensions from about 1 μm to about 1 mm. The μm range includes the “lower μm range,” which refers to a range of dimensions from about 1 μm to about 10 μm, the “middle μm range,” which refers to a range of dimensions from about 10 μm to about 100 μm, and the “upper μm range,” which refers to a range of dimensions from about 100 μm to about 1 mm.

As used herein, the term “size” refers to a characteristic dimension of an object. A size of an object can refer to an actual or geometric dimension of the object, or can refer to an effective dimension of the object, such as an aerodynamic dimension or a hydrodynamic dimension. In the case of an object that is spherical, a size of the object can refer to a diameter of the object. In the case of an object that is non-spherical, a size of the object can refer to an average of various orthogonal dimensions of the object. Thus, for example, a size of a particle that is a spheroidal can refer to an average of a major axis and a minor axis of the particle. When referring to a set of objects as having a specific size, it is contemplated that the objects can have a distribution of sizes around that size. Thus, as used herein, a size of a set of objects can refer to a typical size of a distribution of sizes, such as an average size, a median size, or a peak size.

As used herein, the term “monodisperse” refers to being substantially uniform with respect to a set of characteristics. Thus, for example, a set of particles that are monodisperse can refer to such particles that have a narrow distribution of sizes around a typical size of the distribution of sizes. In some instances, a set of particles that are monodisperse can have sizes exhibiting a standard deviation of less than 20 percent with respect to an average size. such as less than 10 percent or less than 5 percent.

As used herein, the term “monolayer” refers to a single continuous coating of a material with no additional material added beyond the continuous coating.

As used herein, the term “dopant” refers to a chemical entity that is present in a material as an additive or an impurity. In some instances, the presence of a dopant in a material can alter a set of characteristics of the material, such as its chemical, magnetic, electronic, or optical characteristics.

As used herein, the term “electron acceptor” refers to a chemical entity that has a tendency to attract an electron from another chemical entity, while the term “electron donor” refers to a chemical entity that has a tendency to provide an electron to another chemical entity. In some instances, an electron acceptor can have a tendency to attract an electron from an electron donor. It should be recognized that electron attracting and electron providing characteristics of a chemical entity are relative. In particular, a chemical entity that serves as an electron acceptor in one instance can serve as an electron donor in another instance. Examples of electron acceptors include positively charged chemical entities and chemical entities including atoms with relatively high electronegativities. Examples of electron donors include negatively charged chemical entities and chemical entities including atoms with relatively low electronegativities.

As used herein, the term “nanoparticle” refers to a particle that has a size in the nm range. A nanoparticle can have any of a variety of shapes, such as box-shaped, cube-shaped, cylindrical, disk-shaped, spherical, spheroidal, tetrahedral, tripodal, tube-shaped, pyramid-shaped, or any other regular or irregular shape, and can be formed of any of a variety of materials. In some instances, a nanoparticle can include a core formed of a first material, which core can be optionally surrounded by an outer layer formed of a second material. The first material and the second material can be the same or different. It is also contemplated that the core can be optionally surrounded by multiple outer layers. Depending on the configuration of a nanoparticle, the nanoparticle can exhibit size dependent characteristics associated with quantum confinement. However, it is also contemplated that a nanoparticle can substantially lack size dependent characteristics associated with quantum confinement or can exhibit such size dependent characteristics to a low degree.

As used herein, the term “surface ligand” refers to a chemical entity that can be used to form an outer layer of a particle, such as a nanoparticle. A surface ligand can have an affinity for or can be chemically bonded, either covalently or non-covalently, to a core of a nanoparticle. In some instances, a surface ligand can be chemically bonded to a core at multiple portions along the surface ligand. A surface ligand can optionally include a set of active portions that do not interact specifically with a core. A surface ligand can be substantially hydrophilic, substantially hydrophobic, or substantially amphiphilic. Examples of surface ligands include organic molecules, such as hydroquinone, ascorbic acid, silanes, and siloxanes; polymers (or monomers for a polymerization reaction), such as polyvinylphenol; and inorganic complexes. Additional examples of surface ligands include chemical groups, such alkyl groups, alkenyl groups, alkynyl groups, aryl groups, iminyl groups, hydride groups, halo groups, hydroxy groups, alkoxy groups alkenoxy groups, alkynoxy groups, aryloxy groups, carboxy groups, alkylcarbonyloxy groups, alkenylcarbonyloxy groups, alkynylcarbonyloxy groups, arylcarbonyloxy groups, thio groups, alkylthio groups, alkenylthio groups, alkynylthio groups, arylthio groups, cyano groups, nitro groups, amino groups, N-substituted amino groups, alkylcarbonylamino groups, N-substituted alkylcarbonylamino groups, alkenylcarbonylamino groups, N-substituted alkenylcarbonylamino groups, alkynylcarbonylamino groups, N-substituted alkynylcarbonylamino groups, arylcarbonylamino groups, N-substituted arylcarbonylamino groups, silyl groups, and siloxy groups.

### Overview

Embodiments of the invention relate to markings for objects. The markings can serve as security markings that are difficult to reproduce and, thus, can be advantageously used in anti-counterfeiting applications. For example, the markings can be used to verify whether objects bearing those markings are authentic or original. Alternatively, or in conjunction, the markings can serve as identification markings and, thus, can be advantageously used in inventory applications. For example, the markings can be used to track identities or locations of objects bearing those markings as part of inventory control.

For some embodiments of the invention, a marking can be formed with a correlated random pattern, which can provide functional as well as aesthetic advantages. While the marking can be readily formed, randomness within the marking (e.g., below a scale of a standard reproduction technique) renders it difficult or virtually impossible to reproduce. In such fashion, the marking can be envisioned as a physical realization of a cryptographic one-way hash function, namely one having an output that is readily produced but that is difficult or virtually impossible to invert. In addition, the marking can be visually appealing, and can incorporate a variety of colors and shapes within a complex arrangement. As part of a registration process, a reference image of the marking can be obtained, and the reference image can be stored for later comparison. For authentication purposes, an authentication image of the marking can be obtained, and the authentication image can be compared with the reference image. If there is a sufficient match between the images (e.g., with respect to a threshold that is adjustable based on a specific application), an object of interest can be deemed to be authentic or original. Advantageously, the presence of correlation within the marking can be exploited to reduce certain redundant or repeating content within the images. In such fashion, the images can be effectively compressed, thereby facilitating transmission, storage, and matching of the images.

### Security System

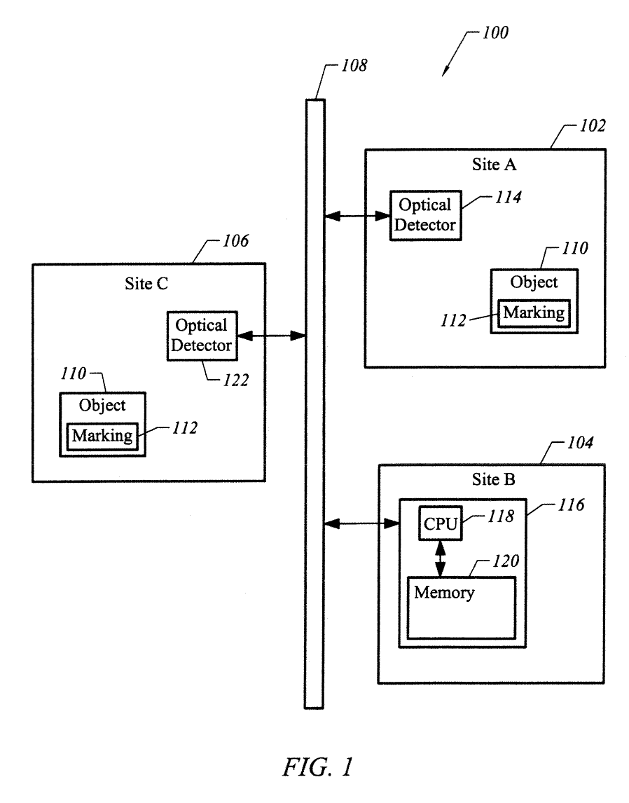

FIG. 1 illustrates a system 100 that is implemented in accordance with an embodiment of the invention. As further described below, the system 100 can be operated as a security system to prevent or reduce counterfeiting of a variety of objects, such as consumer products, credit cards, identification cards, passports, currency, and so forth.

As illustrated in FIG. 1, the system 100 includes a number of sites, including site A 102, site B 104, and site C 106. Site A 102, site B 104, and site C 106 are connected to a computer network 108 via any wired or wireless communication channel. In the illustrated embodiment, site A 102 is a manufacturing site, a distribution site, or a retail site for an object 110, site B 104 is an authentication and registration site for the object 110, and site C 106 is a site at which a customer is located.

The illustrated embodiment can be further understood with reference to a sequence of operations that can be performed using the system 100. First, at site A 102, a marking 112 is applied to the object 110 (or another object that is coupled to or encloses the object 110), which serves as a substrate. For example, the marking 112 can be coated or printed directly on the object 110 or on a label or a stamp that is coupled to the object 110. In the illustrated embodiment, the marking 112 is formed with a correlated random pattern, such as one having self-similar characteristics. As part of a registration process, a reference image of the marking 112 is obtained using an optical detector 114, and the reference image is transmitted to site B 104 along with a request for registration. Desirably, transmission of the reference image can be performed using a secure data transmission technique, such as an encryption technique. Advantageously, randomness within the marking 112 renders the marking 112 difficult or virtually impossible to reproduce. At the same time, the presence of correlation within the marking 112 allows the reference image to be effectively compressed, thereby facilitating its transmission to site B 104. In some instances, multiple reference images of the marking 112 can be obtained using a variety of settings for the optical detector 114, and each of these reference images can be compressed and transmitted to site B 104 for registration. If desired, site B 104 can provide a sequence of tests or a sequence of settings for the optical detector 114, and this sequence can be random to provide enhanced security.

Second, site B 104 receives the reference image and stores the reference image for later comparison. Advantageously, effective compression of the reference image reduces its storage size requirement at site B 104. As illustrated in FIG. 1, site B 104 includes a computer 116, which can be a server computer such as a Web server. The computer 116 includes standard computer components, including a central processing unit (“CPU”) 118 that is connected to a memory 120. The memory 120 can include a database within which the reference image is stored. The memory 120 can also include computer code for performing a variety of image processing operations.

Third, at site C 106, the customer may wish to verify whether the object 110 is authentic or original. As part of an authentication process, an authentication image of the marking 112 is obtained using an optical detector 122, and the authentication image is transmitted to site B 104 along with a request for authentication. If desired, spatial coordinates, such as related to a Global Positioning System (“GPS”) or any other suitable technique, can be included in the request for authentication, such that the location of the customer or the object 110 can be determined. Desirably, transmission of the authentication image can be performed using a secure data transmission technique, such as an encryption technique. Similar to the reference image, the presence of correlation within the marking 112 allows the authentication image to be effectively compressed, thereby facilitating its transmission to site B 104. The optical detector 122 can be operated using similar settings as used for the optical detector 114 when obtaining the reference image. For a reduced level of security, the authentication image can be at a lower resolution and a greater compression level than the reference image. In some instances, multiple authentication images of the marking 112 can be obtained using a variety of settings for the optical detector 122 and each of these authentication images can be compressed and transmitted to site B 104 for authentication. For a reduced level of security, it is contemplated that certain of these authentication images can be omitted or skipped in connection with subsequent image processing operations. If desired, site B 104 can provide a sequence of tests or a sequence of settings for the optical detector 122, and this sequence can be random to provide enhanced security.

Next, site B 104 receives the authentication image and compares the authentication image with the reference image. Advantageously, effective compression of the authentication image and the reference image accelerates and simplifies matching of the images. If the authentication image sufficiently matches the reference image, such as within a certain probability range, site B 104 transmits a message to the customer at site C 106 confirming that the object 110 is authentic. In addition to such confirmation, site B 104 can transmit other information related to the object 110, such as a manufacturing date, a manufacturing location, an expiration date, and so forth. On the other hand, if the authentication image does not sufficiently match the reference image (or any other reference image), site B 104 transmits a message indicating that it is unable to confirm that the object 110 is authentic (or that the object 110 is likely to be a reproduction). Site B 104 can also send authentication information to site A 102, such that a level of counterfeiting can be monitored. Desirably, transmission of authentication information between site A 102, site B 104, and site C 106 can be performed using a secure data transmission technique, such as an encryption technique.

While certain components and operations have been described with reference to specific locations, it is contemplated that these components and operations can be similarly implemented at a variety of other locations. Thus, for example, certain components and operations described with reference to site A 102, site B 104, and site C 106 can be implemented at the same location or at another location that is not illustrated in FIG. 1. Also, while the system 100 has been described with reference to a security system, it is contemplated that the system 100 can also be operated as an inventory system to track identities or locations of a variety of objects as part of inventory control. For example, the marking 112 can be used to encode a specific identifier relating to the object 110.

### Markings for Anti-Counterfeiting and Inventory Applications

For some embodiments of the invention, a marking can encode a set of signatures based on variations in optical or non-optical characteristics across the marking. Typically, at least one signature can be encoded by forming the marking so as to have a correlated random pattern. In some instances, the marking can encode multiple signatures that provide multiple levels of security or identification. Each signature can be used independently of other signatures. and, in some instances, certain signatures can be omitted or skipped for a reduced level of security, a reduced cost, or a reduced processing time. In some instances, each signature can be encoded based on the correlated random pattern, while, in other instances, certain signatures can be encoded based on a separate pattern having distinct colors or shapes. It is also contemplated that a signature providing a lower level of security can be used to reduce a search space for another signature providing a higher level of security. Depending on the specific application, the marking can encode a set of overt signatures, a set of covert signatures, or a combination thereof. An overt signature is one that is visible, while a covert signature is one that is detected using some type of device.

Advantageously, a random aspect of a correlated random pattern renders a resulting marking difficult or virtually impossible to reproduce, while, at the same time, a correlated aspect of the pattern allows an image of the marking to be effectively compressed for transmission, storage, and matching. In addition to its functional advantages, the pattern can be advantageous from an aesthetic standpoint, and can incorporate a variety of colors and shapes within a complex arrangement in two dimensions or three dimensions. Examples of correlated random patterns include those having self-similar characteristics, such as fractal patterns. As can be appreciated, a fractal pattern can appear similar when viewed at different scales of magnification, and can have a fractal dimension based on a degree to which the fractal pattern appears to fill space when viewed at increasingly greater scales of magnification. Depending on its degree of similarity at different scales of magnification, a fractal pattern can be described as being exactly self-similar, quasi self-similar, or statistically self-similar. A fractal pattern can also be described as being self-affine, namely one having a transform that can vary across different directions.

In some instances, a marking having a correlated random pattern can be described with reference to a specific optical or non-optical characteristic c(r) of the marking, where r corresponds to spatial coordinates within the marking. In the case that the pattern is a two-dimensional pattern, r can correspond to, for example. (x, y) within a specific plane of the marking. In the case that the pattern is a three-dimensional pattern, r can correspond to, for example, (x, y, z) within a specific volume of the marking.

In accordance with a random aspect of the pattern, c(r) typically exhibits variations across the marking, such that c(r) can have a distribution of values around a typical value of the distribution of values. In particular, c(r) can be viewed as a random variable having some probability of assuming a specific value at a specific r, and this probability can be derived based on a probability distribution function, such as a Gaussian distribution function. At the same time, in accordance with a correlated aspect of the pattern, variations in c(r) across the marking are typically not independent, such that c(r) at a specific r and c(r′) at a specific r′ can have respective values that are linked or related in some fashion. In particular, c(r) and c(r′) can be viewed as random variables having some tendency of assuming respective values that are positively or negatively related, and this tendency can be derived based on a correlation function, such as G(r, r′)=<(c(r)−c(r′))²> where < . . . >corresponds to an average. Since c(r) and c(r′) are not independent, G(r, r′) is typically not a constant, but is rather a function of r and r′. In particular, G(r, r′) can be a function of r−r′ in the case that the pattern is anisotropic, or can be a function of |r−r″| in the case that the pattern is isotropic. In some instances, c(r) and c(r′) can become effectively independent if r and r′ are spaced farther apart than a specific correlation length ξ, such that G(r, r′) approaches a constant once |r−r′|>>ξ. It is contemplated that c(r) and c(r′) can exhibit a long-range relationship, such that ξ can be undefined or diverging.

In some instances, c(r) can correspond to an optical characteristic of the marking, and variations in c(r) across the marking can provide a specific optical signature that can be used for authentication purposes, identification purposes, or both. In particular, different portions of the marking can be formed of respective materials having different optical characteristics, and the different optical characteristics can provide a resulting image having different colors or different shades of gray. The materials can have different elemental compositions or different concentrations or types of chemical entities, and can form respective domains that are interdispersed, interpenetrating, or layered with respect to one another to form a complex pattern having self-similar characteristics.

For example, c(r) can correspond to a luminescent characteristic of the marking, and variations in c(r) across the marking can provide an optical signature for authentication purposes. In particular, different portions of the marking can be formed from respective materials having different absorption spectra, different emission spectra, different excitation spectra, or a combination thereof, and the different spectra can provide a resulting image having different colors or different shades of gray (i.e., either overt or covert in an emission sense). In some instances, the marking can be formed of a set of interdispersed, interpenetrating, or layered domains, and a distribution of a set of luminescent materials within at least some of the domains can allow an image of the marking to be obtained upon suitable energy excitation.

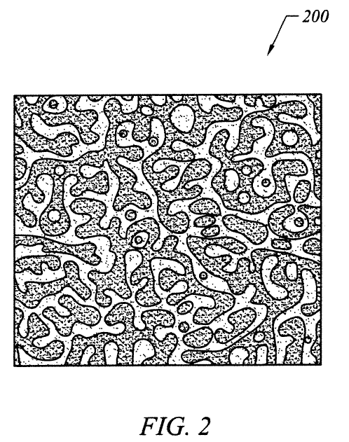

FIG. 2 provides a line drawing 200 replicating an image of a set of domains, according to an embodiment of the invention. As illustrated in FIG. 2, the domains are formed of respective materials having different emission spectra, such that the resulting image has different shades of gray with respective intensities that can be tuned to desired levels. For example, one subset of the domains (e.g., not shaded in FIG. 2) can include a luminescent material that emits light within a specific range of wavelengths, while another subset of the domains (e.g., shaded in FIG. 2) can substantially lack the luminescent material or can include the luminescent material at a relatively low concentration. As another example, one subset of the domains (e.g., not shaded in FIG. 2) can include a luminescent material that emits light within a specific range of wavelengths, while another subset of the domains (e.g., shaded in FIG. 2) can include another luminescent material that emits light within a different range of wavelengths.

As another example, c(r) can correspond to an absorption characteristic of the marking, and variations in c(r) across the marking can provide another optical signature for authentication purposes. In particular, different portions of the marking can be formed of respective materials having different absorption spectra, and the different absorption spectra can provide a resulting image having different colors or different shades of gray (i.e., either overt or covert in a subtractive sense). As a further example, c(r) can correspond to a refractive characteristic of the marking, and variations in c(r) across the marking can provide a further optical signature for authentication purposes. In particular, different portions of the marking can be formed of respective materials having different indices of refraction, and the different indices of refraction can similarly provide a resulting image having different colors or different shades of gray.

In other instances, c(r) can correspond to a structural characteristic of the marking, and variations in c(r) across the marking can also provide a specific signature that can be used for authentication purposes, identification purposes, or both. For example, the marking can be formed with a complex surface topography having self-similar characteristics, and c(r) can correspond to a surface height of the marking. Variations in c(r) across the marking can be detected in accordance with any suitable imaging technique. In some instances, a distribution of a set of luminescent materials within the marking can allow an image of the surface topography to be obtained upon suitable energy excitation. Other examples of c(r) include concentrations of constituent objects, defects, voids, or other inhomogeneities within the marking, and variations in c(r) across the marking can be detected in a similar fashion as described above.

### Formation of Markings

A variety of techniques can be used to form markings described herein. The resulting markings can be truly random, rather than pseudo random as with certain computer-generated “random” numbers. For example, spinodal decomposition can be used to form a marking having a correlated random pattern. Typically, spinodal decomposition involves a separation of an initial homogeneous phase into a set of distinct phases. The initial homogeneous phase can be thermodynamically unstable with respect to compositional fluctuations at or near a spinodal point, and phase separation can occur based on spontaneous amplification of the compositional fluctuations as the initial homogeneous phase is quenched from a single-phase region into an unstable region of a miscibility gap. The resulting phases can have different elemental compositions or different concentrations or types of chemical entities, and can form respective domains within a complex pattern having self-similar characteristics. The pattern can be a two-dimensional pattern, such as one in which the domains form a crack pattern of a thin coating or film, or a three-dimensional pattern, such as one in which the domains are arranged within a volume of a thicker coating or film.

In accordance with spinodal decomposition, a marking can be formed using a coating, ink, or varnish formulation having a suitable composition, such that a solubility parameter of the coating formulation is at or near a spinodal point. In particular, the coating formulation can be a mixture of multiple components, such as component A and component B. Component A and component B can include, for example, respective polymers that differ in some fashion, respective colloidal solutions that differ in some fashion, or a combination thereof. It is also contemplated that the coating formulation can include three or more components. In some instances, the coating formulation can also include a set of pigments, dyes, or other additives to adjust a set of optical or non-optical characteristics of the resulting marking. Desirably, the pigments can be selected so as to match a solubility parameter of one of component A and component B. For example, the coating formulation can include a set of particles dispersed therein, and the particles can be formed of a luminescent material to encode a set of optical signatures for authentication purposes, identification purposes, or both. The particles can have a single size or multiple sizes. Since luminescent characteristics of the particles can be size dependent, the use of multiple sizes can lead to multiple colors. It is also contemplated that the particles can be formed of luminescent materials that differ in some fashion, thereby providing multiple colors. The coating formulation can include the particles as pigments along with one or more of the following additional ingredients: a solvent or a mixture of solvents, a coupling agent, a dispersant, a wetting agent (e.g., a surfactant, such as sodium dodecyl sulfate, a polymeric surfactant, or any other suitable ionic or non-ionic surfactant), an anti-foaming agent, a preservative, a stabilizer, and a pH adjusting agent. To achieve higher levels of security, the coating formulation can further include a set of inert masking agents that provide a mixed compositional signature when performing chemical analysis. Also, the coating formulation can include a relatively low concentration of the particles (e.g., a few micrograms per marking), thus rendering chemical analysis difficult.

Next, a coating or printing technique can be used to apply the coating formulation on an object of interest (or another object that is coupled to or encloses the object of interest), which serves as a substrate. Thus, for example, the coating formulation can be applied using a standard coating technique, such as roller coating or spray coating, or using a standard printing technique, such as ink jet printing, offset printing, gravure printing, flexography printing, intaglio printing, or screen printing. Depending on characteristics of the substrate or a particular coating or printing technique that is used, the coating formulation can permeate at least a portion of the substrate. Once the coating formulation is applied on the substrate, any solvent can be removed by, for example, evaporation or soft bake, which triggers spinodal decomposition. The resulting marking can have one phase that is rich in component A and another phase that is rich in component B, and the pigments can be concentrated within one of the two phases based on matching of solubility parameter.

As another example, self-assembly of suitably shaped objects can be used to form a marking having a correlated random pattern. Typically, self-assembly of objects involves the formation of a two-dimensional or three-dimensional array, such that the objects (or defects or voids between the objects) can be distributed within the array in accordance smith a complex pattern having self-similar characteristics. The objects within the array can correspond to domains similar to those produced by spinodal decomposition. In particular, the objects can be shaped so as to allow aperiodic tiling, namely one that is non-repeating. Examples of aperiodic tiling include Penrose tiling and Wang tiling.

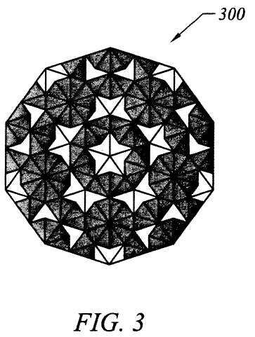

FIG. 3 illustrates a two-dimensional array 300 formed via Penrose tiling, according to an embodiment of the invention. As illustrated in FIG. 3, objects having a pair of different shapes, namely “dart” (dark shaded in FIG. 3) and “kite” (lightly shaded in FIG. 3), are arranged so as to form the array 300 that is non-repeating but that exhibits a certain degree of rotational symmetry and mirror-image symmetry. Referring to FIG. 3, the objects are formed of materials having different absorption spectra or emission spectra, such that a resulting image has different shades of gray with respective intensities that can be tuned to desired levels. For example, one subset of the objects (e.g., lightly shaded in FIG. 3) can include a luminescent material that emits light within a specific range of wavelengths, while another subset of the objects (e.g., dark shaded in FIG. 3) can substantially lack the luminescent material or can include the luminescent material at a relatively low concentration. As another example, one subset of the objects (e.g., lightly shaded in FIG. 3) can include a luminescent material that emits light within a specific range of wavelengths, while another subset of the objects (e.g., dark shaded in FIG. 3) can include another luminescent material that emits light within a different range of wavelengths. While not illustrated in FIG. 3, two-dimensional arrays having similar characteristics can also be formed from objects having other pairs of shapes, such as “thin rhombus” and “thick rhombus.” Alternatively, or in conjunction, objects shaped so as to allow Wang tiling and having different thicknesses can provide a specific optical signature based on, for example, scattering of light. It is also contemplated that three-dimensional arrays within quasi-crystals can be formed from objects having suitable shapes, such as icosahedral shapes.

In accordance with self-assembly, a marking can be formed using a coating, ink, or varnish formulation having a set of suitably shaped objects dispersed therein. The objects can be formed using any suitable technique, such as a die cutting technique or a polymer molding technique for poly(methyl methacrylate), polyethylene, polystyrene, or another plastic. The objects can have different thicknesses, which can provide a specific optical signature based on scattering of light. In some instances, at least some of the objects can include a set of pigments, dyes, or other additives to adjust a set of optical or non-optical characteristics of the resulting marking. For example, certain of the objects can include a set of particles dispersed therein, and the particles can be formed of a luminescent material to encode a set of optical signatures for authentication purposes, identification purposes, or both. The particles can have a single size or multiple sizes. Since luminescent characteristics of the particles can be size dependent, the use of multiple sizes can lead to multiple colors. It is also contemplated that the particles can be formed of luminescent materials that differ in some fashion, thereby providing multiple colors. The coating formulation can include the objects along with one or more of the following additional ingredients: a solvent or a mixture of solvents, a coupling agent, a dispersant, a wetting agent, an anti-foaming agent, a preservative, a stabilizer, and a pH adjusting agent. In particular, the coating formulation desirably includes a coupling agent and a wetting agent, which can promote self-assembly of the objects by facilitating edge coupling. To achieve higher levels of security, the coating formulation can further include a set of inert masking agents that provide a mixed compositional signature when performing chemical analysis.

Next, a coating or printing technique can be used to apply the coating formulation on an object of interest (or another object that is coupled to or encloses the object of interest), which serves as a substrate. Depending on characteristics of the substrate or a particular coating or printing technique that is used, the coating formulation can permeate at least a portion of the substrate. Once the coating formulation is applied on the substrate, any solvent can be removed by, for example, evaporation or soft bake, which triggers self-assembly of the objects. In some instances, self-assembly at the objects can be promoted by applying a suitable energy excitation, such as acoustic or vibrational energy. An additional coating or varnish formulation can be applied on a resulting array of the objects so as to retain the objects within the array.

Markings having correlated random patterns can be formed using a variety of other techniques, such as those relating to formation of fracture surfaces; Liesegang patterns; photonic crystals, opals, or other quasi-crystals with defects; Turing patterns; and so forth. For example, a quasi-crystal can be formed so as to have a set of defects that are distributed in accordance with a complex pattern having self-similar characteristics. The quasi-crystal can be formed via self-assembly or sedimentation of colloidal objects, such as latex beads, silica beads, or colloidal silica in a polymer system. In some instances, at least some of the objects can include a set of pigments, dyes, or other additives to adjust a set of optical or non-optical characteristics of the quasi-crystal. Alternatively, or in conjunction, the quasi-crystal can be formed via holographic lithography. As another example, a marking can be formed with a Liesegang pattern, namely one based on a reaction-diffusion process that can produce a set of bands or tree structures having self-similar characteristics. The reaction-diffusion process can occur in a diffusive medium, such as a gel or a porous material, and can involve precipitation of silver halides or gold nanoparticles or formation of chemical entities having a set of colors. As a further example, a marking can be formed with a Turing pattern, namely one based on a reaction-diffusion process that can produce a spatial arrangement having a specific scale. The scale can be dependent on diffusion coefficients of a set of reactants, and can be adjusted over a wide range. One type of Turing pattern is one based on the Belousov-Zhabotinsky reaction, which is a temporal reaction that can produce a spatial arrangement based on a variety of shapes, such as hexagons, stripes, honeycombs, or labyrinthine, and having a set of colors or other optical characteristics. The reaction can occur in a diffusive medium, such as a gel, a porous material, or a liquid, and can be stopped at a specific point by reducing a temperature or solidifying the diffusive medium, such as by removing any solvent by evaporation.

Markings having correlated random patterns can also be formed using certain decorative techniques such as decalcomania. For example, in accordance with decalcomania, a viscous material can be applied on one sheet or film, and the viscous material can include a set of pigments, dyes, or other additives to adjust a set of optical or non-optical characteristics of the viscous material. Next, another sheet or film can be applied on the viscous material, and pressure can be applied so as to flatten and spread the viscous material between the two sheets. When the two sheets are pulled apart, certain portions of the viscous material can adhere to the two sheets, and can form a set of ridges or branching structures having self-similar characteristics.

### Optical Detectors

A variety of optical detectors can be used to detect markings described herein. Typically, an optical detector includes a light source and a reader that is coupled to the light source. In some instances, sunlight or ambient light can be used as the light source. To facilitate registration of objects as well as subsequent authentication and identification of those objects, a portable computing device can be used as an optical detector. Examples of portable computing devices include laptop computers, palm-sized computers, tablet computers, personal digital assistants, cameras, and cellular telephones.

A. Light Source

Depending on specific characteristics of a marking, a light source can produce incident light having a set of wavelengths in the ultraviolet range, visible range, infrared range, or a combination thereof. For the detection of an image based on luminescence, the set of wavelengths of the incident light can be matched with an absorption spectrum of a luminescent material forming the marking. For a combination of luminescent materials having different absorption spectra, the incident light can have multiple sets of wavelengths that are matched with the different absorption spectra. The incident light can be coherent or incoherent. Also, the incident light can be collimated or quasi-collimated, such as produced by a laser or focused by a lens, and the degree of collimation can affect luminescent and other optical characteristics. In some instances, the incident light can be modulated, such as in accordance with an amplitude modulation scheme or a frequency modulation scheme, and such modulation can be used to provide improved detection sensitivity.

Examples of light sources include incandescent light sources, light emitting diodes, lasers, sunlight, and ambient light. In some instances, a laser can be desirable, since it can provide coherent light that can be used for coherent detection, which can allow improved detection sensitivity. In other instances, a color video monitor, a computer monitor screen, or other color display screen, such as of a cellular telephone phone, can be used as a light source. In yet other instances, a flash unit, such as of a camera or a cellular telephone phone equipped with a camera, can be used as a light source.

B. Reader

A reader can be implemented in a variety of ways, including using a set of photo-detectors, such as a set of silicon-based photo-detectors or gallium arsenide-based photo-detectors; an imager, such as a multi-dimensional imager; a charge-coupled device, such as one included in a digital camera; or a combination thereof. For the detection of an image based on luminescence, a sensitivity of the reader can be matched with an emission spectrum of a luminescent material forming a marking. For a combination of luminescent materials having different emission spectra, the reader can have a sensitivity that is matched with the different emission spectra. The reader can operate in accordance with a suitable imaging technique, such as scanned imaging, time-resolved tomographic imaging, or optical coherence tomographic imaging. In the case that the marking is formed as a thin coating or film, such as one that is about 10 μm or less in thickness, the marking can be effectively viewed in two dimensions within a single optical plane. In the case of a thicker coating or film, the marking can be viewed in three dimensions within multiple optical planes. In this case, a resulting image of the marking can depend on a viewing angle of the reader. If desired, the marking can be viewed from multiple directions and angles, resulting in different images.

The reader can also include a set of optical elements, such as lenses, apertures, interferometers, optical filters, polarizers, spectrometers, and combinations thereof. In some instances, an optical filter can be used to select emitted light or to remove contributions from incident light or other background noise. The optical filter can be a short wavelength cutoff filter, a long wavelength cutoff filter, or a notch filter. In the case of a laser that provides coherent light, coherent detection can be used along with a suitable modulation scheme to provide improved detection sensitivity, such as using lock-in amplification. In this case, the set of optical elements can provide a split optical path.

### Image Processing

A variety of image processing techniques can be used for converting a raw image of a marking into a suitable form for transmission, storage, and matching. In particular, a variety of image compression techniques, such as fractal image compression techniques, optical correlation techniques, optical transform techniques, and wavelet-based techniques, can be used for transmission and storage of the raw image. Typically, these image compression techniques operate to reduce certain redundant or repeating content within the raw image, thereby allowing the raw image to be represented in a compressed form having a reduced set of information. In some instances, this reduced set of information can include compression codes, such as fractal codes, which can represent the raw image in terms of its self-similar characteristics. Advantageously, the presence of correlation within the marking can translate into a greater amount of redundant or repeating content within the raw image, thereby allowing higher compression ratios.

To facilitate authentication and identification of an object bearing a marking, comparison of images of the marking can be performed based on compressed forms of the images. A variety of techniques can be used for comparing the images to determine whether there is a sufficient match. For example, comparison of the images can be performed with respect to their compression codes. In some instances, multiple authentication images of the marking can be obtained using a variety of settings for an optical detector, and each of these authentication images can be compared with a corresponding reference image for an enhanced level of security. Alternatively, it is contemplated that certain of these authentication images can be selectively omitted or skipped for a reduced level of security.

### Luminescent Materials

A variety of luminescent materials can be used to form markings described herein. Particularly desirable luminescent materials include those exhibiting a combination of photoluminescent characteristics, such as those related to quantum efficiency, spectral width, spectral separation, absorption wavelengths, and emission wavelengths.

In particular, luminescent materials according to some embodiments of the invention can exhibit photoluminescence with a high quantum efficiency, thereby facilitating detection or imaging of the luminescent materials upon irradiation. In some instances, the quantum efficiency can be greater than about 6 percent, such as at least about 10 percent, at least about 20 percent, at least about 30 percent, at least about 40 percent, or at least about 50 percent, and can be up to about 90 percent or more. As can be appreciated, a high quantum efficiency can translate into a higher relative intensity for emitted light and an improved signal-to-noise ratio with respect to incident light or other background noise.

Also, the luminescent materials can exhibit photoluminescence with a narrow spectral width and a large spectral separation, thereby further facilitating detection or imaging of the luminescent materials upon irradiation. In some instances, the spectral width can be no greater than about 120 nm at FWHM, such as no greater than about 100 nm, no greater than about 80 nm, or no greater than about 50 nm at FWHM. Thus, for example, the spectral width can be in the range of about 50 nm to about 120 nm at FWHM, such as from about 50 nm to about 100 nm or from about 50 nm to about 80 nm at FWHM. As another example, the spectral width can be in the range of about 10 nm to about 50 nm at FWHM, such as from about 10 nm to about 40 nm, from about 10 nm to about 30 nm, or from about 10 nm to about 20 nm at FWHM. As can be appreciated, a narrow spectral width can translate into an improved resolution for emitted light with respect to incident light or other background noise. However, it is also contemplated that the spectral width can be greater than about 120 nm at FWHM, such as about 250 nm at FWHM for certain luminescent materials. For a given spectral width, an insufficient spectral separation between absorption wavelengths and emission wavelengths can sometimes lead to an undesirable signal-to-noise ratio with respect to incident light or other background noise. Thus, it can also be desirable that the luminescent materials have an adequate spectral separation, such that, for example, a peak absorption wavelength and a peak emission wavelength can be spaced apart by at least about 100 nm, such as at least about 150 nm or at least about 200 nm.

In addition, the luminescent materials can exhibit photoluminescence with absorption wavelengths and emission wavelengths that are located within desirable ranges of wavelengths. In some instances, either of, or both, the absorption wavelengths and the emission wavelengths can be located in the infrared range. Thus, for example, a peak emission wavelength can be located in the near infrared range, such as from about 900 nm to about 1 μm, from about 910 nm to about 1 μm, from about 910 nm to about 980 nm, or from about 930 nm to about 980 nm. As another example, the peak emission wavelength can be located in the range of about 700 nm to about 800 nm, such as from about 700 nm to about 750 nm or from about 700 nm to about 715 nm. However, it is also contemplated that the peak emission wavelength can be located in the middle infrared range, the far infrared range, the ultraviolet range, or the visible range. As can be appreciated, emission of light in the infrared range is not visible and, thus, can be advantageously exploited to encode covert signatures for anti-counterfeiting applications.

Examples of luminescent materials include those formed via a conversion of a set of ingredients into the luminescent materials at high yields and at moderate temperatures and pressures. The conversion can be represented with reference to the formula:

Source(B)+Source(A,X)→Luminescent Material (I)

In formula (I), source(B) serves as a source of B, and, in some instances. source(B) can also serve as a source of dopants. B can be selected from elements having suitable oxidation states, such that their ground electronic states include filled s orbitals and can be represented as (ns)². Examples of B include elements of Group VA, such as vanadium (e.g., as V(III) or V⁺³); elements of Group IB, such as copper (e.g., as Cu(I) or Cu⁺¹), silver (e.g., as Ag(I) or Ag⁺¹), and gold (e.g., as Au(I) or Au⁺¹); elements of Group IIB, such as zinc (e.g., as Zn(II) or Zn⁺²), cadmium (e.g., as Cd(II) or Cd⁺²), and mercury (e.g., as Hg(II) or Hg⁺²); elements of Group IIIB, such as gallium (e.g., as Ga(I) or Ga⁺¹), indium (e.g., as In(I) or In⁺¹), and thallium (e.g., as Tl(I) or Tl⁺¹); elements of Group IVB, such as germanium (e.g., as Ge(II) or Ge² or as Ge(IV) or Ge⁺⁴), tin (e.g., as Sn(II) or Sn⁺² or as Sn(IV) or Sn⁺⁴), and lead (e.g., as Pb(II) or Ph⁺²or as Pb(IV) or Pb⁺⁴); and elements of Group VB, such as bismuth (e.g., as Bi(III) or Bi⁺³).

In the case that B is tin, for example, source(B) can include one or more types of tin-containing compounds selected from tin(II) compounds of the form BY, BY₂, B₃Y₂, and B₂Y and tin (IV) compounds of the form BY₄, where Y can be selected from elements of Group) VIB. such as oxygen (e.g., as O⁻²); elements of Group VIIB, such as fluorine (e.g., as F⁻¹), chlorine (e.g., as C⁻¹), bromine (e.g., as Br⁻¹), and iodine (e.g., as I⁻¹); and poly-elemental chemical entities, such as nitrate (i.e., NO₃⁻¹), thiocyanate (i.e., SCN⁻¹), hypochlorite (i.e., OCl⁻¹), sulfate (i.e., SO₄⁻²), orthophosphate (i.e., PO₄⁻³), metaphosphate (i.e., PO₃⁻¹), oxalate (i.e., C₂O₄⁻²), methanesulfonate (i.e., CH₃SO₃⁻¹), trifluoromethanesulfonate (i.e., CF₃SO₃⁻¹), and pyrophosphate (i.e., P₂O₇⁻⁴). Examples of tin(II) compounds include tin(II) fluoride (i.e., SnF₂), tin(II) chloride (i.e., SnCl₂), tin(II) chloride dihydrate (i.e., SnCl₂.2H₂O), tin(II) bromide (i.e., SnBr₂), tin(II) iodide (i.e., SnI₂), tin(II) oxide (i.e., SnO), tin(II) sulfate (i.e., SnSO₄), tin(II) orthophosphate (i.e., Sn₃(PO₄)₂), tin(II) metaphosphate (i.e., Sn(PO₃)₂), tin(II) oxalate (i.e., Sn(C₂O₄)), tin(II) methanesulfonate (i.e., Sn(CH₃SO₃)₂), tin(II) pyrophosphate (i.e., Sn₂P₂O₇), and tin(II) trifluoromethanesulfonate (i.e., Sn(CF₃SO₃)₂). Examples of tin (IV) compounds include tin(IV) chloride (i.e., SnCl₄) and tin(IV) chloride pentahydrate (i.e., SnCl₄.5H₂O).

In formula (I), source(A, X) serves as a source of A and X, and, in some instances, source(A, X) can also serve as a source of dopants. A is a metal that can be selected from elements of Group IA, such as sodium (e.g., as Na(I) or Na¹⁺), potassium (e.g., as K(I) or K¹⁺), rubidium (e.g., as Rb(I) or Rb¹⁺), and cesium (e.g., as Cs(I) or Cs¹⁺), while X can be selected from elements of Group VIIB, such as fluorine (e.g., as F⁻¹), chlorine (e.g., as Cl⁻¹), bromine (e.g., as Br⁻¹), and iodine (e.g., as I⁻¹). Examples of source(A, X) include alkali halides of the form AX. In the case that A is cesium, for example, source(A, X) can include one or more types of cesium(I) halides, such as cesium(I) fluoride (i.e., CsF), cesium(I) chloride (i.e., CsCl), cesium(I) bromide (i.e., CsBr), and cesium(I) iodide (i.e., CsI).

The conversion represented by formula (I) can be performed by mixing source(B) and source(A, X) in a dry form, in solution, or in accordance with any other suitable mixing technique. It is also contemplated that a vacuum deposition technique can be used in place of, or in conjunction with, a mixing technique. For example, source(B) and source(A, X) can be provided in a powdered form, and can be mixed using a mortar and a pestle. As another example, source(B) and source(A, X) can be dispersed in a reaction medium to form a reaction mixture. The reaction medium can include a solvent or a mixture of solvents, which can be selected from a variety of standard solvents. In some instances, the conversion of source(B) and source(A, X) into a luminescent material can be facilitated by applying a suitable energy excitation, such as acoustic or vibrational energy, electrical energy, magnetic energy, mechanical energy, optical energy, or thermal energy. It is also contemplated that multiple forms of energy excitation can be applied simultaneously or sequentially. For example, source(B) and source(A, X) can be mixed in a dry form, and the resulting mixture can be pressed to a pressure in the range of about 1×10⁵ Pascal to about 7×10⁸ Pascal, such as using a standard pellet press or a standard steel die, to form the luminescent material in a pellet form. As another example, source(B) and source(A, X) can be mixed in a dry form, and the resulting mixture can be heated to a temperature in the range of about 50° C. to about 650° C., such as from about 80° C. to about 350° C. or from about 80° C. to about 300° C., to form the luminescent material. If desired, heating can be performed in an inert atmosphere (e.g., a nitrogen atmosphere) or a reducing atmosphere for a time period in the range of about 0.5 hour to about 9 hours.

In formula (I), the resulting luminescent material can include A, B, and X as major elemental components as well as elemental components derived from or corresponding to Y. Also, the luminescent material can include additional elemental components, such as carbon, chlorine, hydrogen, and oxygen, that can be present in amounts that are less than about 5 percent in terms of elemental composition, and further elemental components, such as sodium, sulfur, phosphorus, and potassium, that can be present in trace amounts that are less than about 0.1 percent in terms of elemental composition.

Without wishing to be bound by a particular theory, some embodiments of the luminescent material of formula (I) can be represented with reference to the formula:

[AₐB_{b}Xₓ][dopants] (II)

In formula (II), a is an integer that can be in the range of 1 to 9, such as from 1 to 5; b is an integer that can be in the range of 1 to 5, such as from 1 to 3; and x is an integer that can be in the range of 1 to 9, such as from 1 to 5. It is also contemplated that one or more of a, b, and x can have fractional values within their respective ranges. It is further contemplated that Xₓ in formula (II) can be more generally represented as XₓX′_{x′}X″_{x″}, where X, X′, and X″ can be independently selected from elements of Group VIIB, and the sum of x, x′, and x″ can be in the range of 1 to 9, such as from 1 to 5.

In the case that A is cesium, B is tin, and X is iodine, for example, the luminescent material can be represented with reference to one of the formulas:

[CsSnI₃][dopants] (III)

[CsSn₂I₅][dopants] (IV)

[CsSn₃I₇][dopant] (V)

In the case of formula III, for example, the resulting luminescent material can have a perovskite-based microstructure that is layered with relatively strong chemical bonding along a particular layer but relatively weak chemical bonding between different layers. This perovskite-based microstructure can undergo transitions between a variety of phases that have different colors.

In the case that A is cesium, B is indium, and X is iodine, for example, the luminescent material can be represented with reference to the formula:

[CsInI][dopants] (VI)

In the case that A is cesium, B is germanium, and X is iodine, for example, the luminescent material can be represented with reference to the formula:

[CsGeI₃][dopants] (VII)

In the case that A is rubidium, B is tin, and X is iodine, for example, the luminescent material can be represented with reference to the formula:

[RbSnI₃][dopants] (VIII)

In the case that A is potassium, B is tin, and X is iodine, for example, the luminescent material can be represented with reference to the formula:

[KSnI₃][dopants] (IX)

In the case that A is cesium, B is indium, and X is bromine, for example, the luminescent material can be represented with reference to the formula:

[CsInBr][dopants] (X)

In the case that A is cesium, B is tin, and X is bromine, for example, the luminescent material can be represented with reference to the formula:

[CsSnBr₃][dopants] (XI)

The dopants included in the luminescent material can be present in amounts that are less than about 5 percent in terms of elemental composition, and can derive from source(A) or other ingredients that are used to form the luminescent material. In the case that A is cesium, B is tin, and N is iodine, for example, the dopants can include cations derived from or corresponding to tin (e.g., Sn(IV) or Sn⁺⁴ cations derived from oxidation of tin) and anions derived from or corresponding to Y (e.g., F⁻¹, Cl⁻¹, Br⁻¹, I⁻¹, or CH₃SO₃⁻¹ anions). The cations and anions can form electron acceptor/electron donor pairs that are dispersed within a microstructure of the luminescent material. Again, without wishing to be bound by a particular theory, photoluminescent characteristics of the luminescent material can derive at least partly from the presence of these electron acceptor/electron donor pairs within that microstructure.

Other examples of luminescent materials include oxides, such as transition metal oxides, post-transition metal oxides, wide band gap semiconductor oxides, indirect band gap semiconductor oxides, and any other stable oxides; sulfides, and phosphates. The oxides, sulfides, and phosphates can include dopants selected from transition metals and rare earth elements that exhibit photoluminescence. Thus, for example, desirable luminescent materials can include zinc oxide (i.e., ZnO) doped with manganese (e.g., as Mn or having another suitable oxidation state), titanium oxide (i.e., TiO₂) doped with manganese (e.g., as Mn or having another suitable oxidation state), lanthanum phosphate (i.e., LaPO₄) doped with cerium (e.g., as Ce or having another suitable oxidation state) or another rare earth element, and silicon oxide (i.e., SiO₂) doped with a transition metal or a rare earth element. Table 1 below provides further examples of desirable luminescent materials along with their peak absorption wavelengths and peak emission wavelengths.

TABLE 1

| Photoluminescent | Peak Absorption | Peak Emission |
|---|---|---|
| Material | Wavelength | Wavelength |
| SrY₂O₄:Eu³⁺ | 250 nm | 611 nm |
| Bi₄Ge₃O₁₂ | 270 nm | 485 nm |
| Gd₃Ga₅O₁₂:Cr³⁺ | 365 nm | 730 nm |
| K₂La₂Ti₃O₁₀:Eu³⁺ | 365 nm | 594 nm |
| K₂La₂Ti₃O₁₀:Eu³⁺ | 365 nm | 617 nm |
| K₂La₂Ti₃O₁₀:Eu³⁺ | 365 nm | 702 nm |
| ZnGa₂O₄ | 250 nm | 460 nm |
| ZnGa₂O₄:Mn²⁺ | 270 nm | 505 nm |
| ZnO:Bi³⁺ | 430 nm | 645 nm |
| ZnO:Ga³⁺ | 250 nm | 388 nm |
| CaO:Zn²⁺ | 250 nm | 370 nm |
| CaO:Eu³^{⁺} | 410 nm | 600 nm |
| CaO:Tb³⁺ | 420 nm | 560 nm |
| Y₂O₂S:Er³⁺ | 980 nm | 548 nm |
| ZnO:S | 250 nm | 500 nm |
| ZnS:Mn²⁺ | 580 nm | 350 nm |
| ZnS:Eu²⁺ | 540 nm | 400 nm |

Further examples of luminescent materials include indirect band gap semiconductors, such as elements of Group IVB including silicon and germanium; semiconductors, such as InP and FeSi; organic dyes, such as phthalocyanines and porphorines; and metals, such as noble metals, gold, silver, copper, and other metals that have an absorption edge or a plasmon resonance in the ultraviolet range, the visible range, or the infrared range.

### Nanoparticles Formed of Luminescent Materials

Luminescent materials according to some embodiments of the invention can be formed as particles having a range of sizes, such as in the sub-nm range, the nm range, or the μm range. Alternatively, the luminescent materials can be formed in a bulk or pellet form and subsequently processed to form the particles. Methods for forming the particles include hydrothermal and chemical precipitation, sintering, and powdering, such as via ball milling, jar milling, or ultrasonic treatment. The resulting particles can be monodisperse or polydisperse with respect to their shapes and sizes. As further described below, each of the particles can include an outer layer, which can be formed using any suitable coating or encapsulation technique.

For certain anti-counterfeiting and inventory applications, particles having sizes in the nm range, such as the lower nm range, the middle nm range, or the upper nm range, can be used to form a coating, ink, or varnish formulation. These nanoparticles can be monodisperse with respect to either of, or both, their shapes and sizes. Such characteristics of the nanoparticles can be desirable so as to facilitate incorporation of the nanoparticles in the coating formulation, which, in turn, can be used to form markings for objects. In particular, such characteristics can allow adequate dispersion of the nanoparticles within the coating formulation, and can allow the coating formulation to be readily applied using a standard coating or printing technique. In addition, the presence of the nanoparticles in the resulting markings can be relatively unnoticeable, such that the markings can serve as covert markings for anti-counterfeiting applications.

In some instances, a nanoparticle can include a core formed of a luminescent material, and the core can be optionally surrounded by an outer layer. Depending on the specific application, the core can be formed of a single luminescent material or multiple luminescent materials that differ in some fashion. The core can have any of a variety of shapes, such as cylindrical, disk-shaped, spherical, spheroidal, or any other regular or irregular shape, and can have a range of sizes, such as in the lower nm range or the middle nm range.

The outer layer can provide environmental protection and isolation for the core. thereby providing improved stability to the core and retaining desirable luminescent characteristics for a prolonged period of time. The outer layer can also provide chemical compatibility with a solvent or a polymer when forming a coating formulation, thereby improving dispersion of the nanoparticle in the resulting formulation. The outer layer can be formed of any of a variety of inorganic and organic materials, such as intrinsic semiconductors; intrinsic insulators; oxides, such as silicon oxide, aluminum oxide, titanium oxide, and zirconium oxide; metals; metal alloys; and surface ligands. Thus, for example, the outer layer can be formed as a shell that surrounds the core. As another example, the outer layer can be formed as a ligand layer that surrounds the core. Depending on the specific application, the outer layer can be formed of a single material or multiple materials that differ in some fashion.

In some instances, the outer layer can be “complete,” such that the outer layer completely covers a surface of the core to cover all surface atoms of the core. Alternatively, the outer layer can be “incomplete,” such that the outer layer partially covers the surface of the core to partially cover the surface atoms of the core. The outer layer can have a range of thicknesses. such as in the sub-nm range, the lower nm range, or the middle nm range. The thickness of the outer layer can also be expressed in terms of a number of monolayers of a material forming the outer layer. Thus, for example, the thickness of the outer layer can be in the range of about 0 to about 20 monolayers, such as from about 1 to about 10 monolayers. A non-integer number of monolayers can correspond to a case in which the outer layer includes incomplete monolayers. Incomplete monolayers can be homogeneous or inhomogeneous, and can form islands or clumps on the surface of the core. Depending on the specific application, the outer layer can include multiple sub-layers that are formed of the same material or different materials in an onion-like configuration.

### EXAMPLES

The following examples describe specific aspects of some embodiments of the invention to illustrate and provide a description for those of ordinary skill in the art. The examples should not be construed as limiting the invention, as the examples merely provide specific methodology useful in understanding and practicing some embodiments of the invention.

### Example 1

### Formation of Marking

A mixture was prepared from three stock solutions, namely 0.3 ml of stock solution 1 (0.52 g of polystyrene in 10 ml of toluene), 0.3 ml of stock solution 2 (0.51 g of polystyrene-co-poly(methyl methacrylate) in 10 ml of toluene), and 0.01 ml of stock solution 3 (1.2 mg of ADS RE100 light-emitting polymer in 0.6 ml of toluene). The mixture was drop-casted on a glass slide, and solvents were evaporated under ambient conditions. A resulting thin film was observed to have a correlated random pattern, and to exhibit luminescence upon irradiation with light in the ultraviolet range (e.g., 365 nm).

### Example 2

### Formation of Marking

A mixture was prepared from two stock solutions, namely 1 ml of stock solution 1 (0.52 g of polystyrene in 10 ml of toluene) and 1 ml of stock solution 5 (colloidal silica in dimethylactemide—available from Nissan Chemicals). The mixture was drop-casted on a glass slide, and solvents were evaporated under ambient conditions. A resulting thin film was observed to have a correlated random pattern.

### Example 3

### Formation of Marking

A mixture was prepared from two stock solutions, namely 0.1 ml of stock solution 1 (0.52 g of polystyrene in 10 ml of toluene) and 0.1 ml of stock solution 2 (0.51 g of polystyrene-co-poly(methyl methacrylate) in 10 ml of toluene). The mixture was drop-casted on a glass slide, and solvents were evaporated under ambient conditions. A resulting thin film was observed to have a correlated random pattern.

### Example 4

### Formation of Marking

A mixture was prepared from three stock solutions, namely 0.3 ml of stock solution 1 (0.52 g of polystyrene in 10 ml of toluene), 0.3 ml of stock solution 2 (0.51 g of polystyrene-co-poly(methyl methacrylate) in 10 ml of toluene), and 0.01 ml of stock solution 6 (12.8 mg of a luminescent material in a suitable solvent). The mixture was drop-casted on a glass slide, and solvents were evaporated under ambient conditions. A resulting thin film, was observed to have a correlated random pattern, and to exhibit luminescence in the near infrared range.

### Example 5

### Formation of Marking

Stock solution 4 (2 g of poly(methyl methacrylate) in 10 ml of tetrahydrofuran) was drop-casted on a glass slide, and a solvent was evaporated under ambient conditions. A resulting thin film was observed to have a correlated random pattern.

It should be recognized that the embodiments of the invention described above are provided by way of example, and various other embodiments and advantages are provided by the invention.

Certain embodiments of the invention relate to a computer storage product with a computer−readable medium including data structures and computer code for performing a set of computer-implemented operations. The medium and computer code can be those specially designed and constructed for the purposes of the invention, or they can be of the kind well known and available to those having ordinary skill in the computer software arts. Examples of computer−readable media include: magnetic media such as hard disks, floppy disks, and magnetic tape; optical media such as Compact Disc-Read Only Memories (“CD-ROMs”) and holographic devices; magneto-optical media such as floptical disks: and hardware devices that are specially configured to store and execute computer code, such as Application-Specific Integrated Circuits (“ASICs”), Programmable Logic Devices (“PLDs”), Read Only Memory (“ROM”) devices, and Random Access Memory (“RAM”) devices. Examples of computer code include machine code, such as produced by a compiler, and files including higher-level code that are executed by a computer using an interpreter. For example, an embodiment of the invention can be implemented using Java, C++, or other object-oriented programming language and development tools. Additional examples of computer code include encrypted code and compressed code. Moreover, an embodiment of the invention can be downloaded as a computer program product, which can be transferred from a remote computer to a requesting computer by way of data signals embodied in a carrier wave or other propagation medium via a transmission channel. Accordingly, as used herein, a carrier wave can be regarded as a computer-readable medium. Another embodiment of the invention can be implemented in hardwired circuitry in place of, or in combination with, computer code.

A practitioner of ordinary skill in the art requires no additional explanation in developing the apparatus, system, and method described herein but may nevertheless find some helpful guidance by examining the patent application of Midgley el cl. U.S. application Ser. No. 11/518,505, entitled “Authenticating and Identifying Objects Using Nanoparticles” and filed on Sep. 8, 2006; the patent application of Varadarajan et al., U.S. Provisional Application Ser. No. 60/784,863, entitled “Luminescent Materials that Emit Light in the Visible Range or the Near Infrared Range” and filed on Mar. 21, 2006; the patent application of Midgley et al, U.S. Provisional Application Ser. No. 60/784,560, entitled “Authenticating and Identifying Objects by Detecting Markings Through Turbid Materials” and filed on Mar. 21, 2006; and the patent of Lee et al., U.S. Pat. No. 6,794,265, entitled “Methods of Forming Quantum Dots of Group IV Semiconductor Materials” and issued on Sep. 21, 2004; the disclosures of which are incorporated herein by reference in their entireties.

A practitioner of ordinary skill in the art may also find some helpful guidance regarding characterization and formation of markings by examining the following references: Bowden et al., “Self-Assembly of Mesoscale Objects into Ordered Two-Dimensional Arrays,” Science, vol. 276, pp. 233-235, 1997; Seol et al., “Three-Dimensional Phase-Field Modeling of Spinodal Decomposition in Constrained Films,” Metals & Materials vol. 9, pp. 3-8, 2003; Siggia, “Late Stages of Spinodal Decomposition in Binary Mixtures,” Phys. Rev. A, vol. 20. pp. 595-605, 1979; Velikov et al., “Photonic Crystals of Shape-Anisotropic Colloidal Particles,” Applied Physics Letters, vol. 81, pp. 838-840, 2002; Yi et al., “Surface-Modulation-Controlled Three-Dimensional Colloidal Crystals,” Applied Physics Letters, vol. 80, pp. 225-227, 2002; Sánchez, Thesis of Technische Universiteit Eindhoven entitled “Spinodal Decomposition in Thin Films of Binary Polymer Blends,” Appendix II, 2002; Kolakowska et al., “Universal Scaling in Mixing Correlated Growth with Randomness,” Phys. Rev. E, vol. 73, pp. 11603.1-11603.4, 2006; Man et al., “Experimental Measurement of the Photonic Properties of Icosahedral Quasicrystals,” Nature, vol. 436, pp. 993-996, 2005; Wang et al., “Realization of Optical Periodic Quasicrystals Using Holographic Lithography,” Applied Physics Letters, vol. 88, pp. 051901.1-051901.3, 2006; Breen et al., “Design and Self-Assembly of Open, Regular, 3D Mesostructures,” Science, vol. 284, pp. 948-951, 1999; Gaponik et al., “Structure-related Optical Properties of Luminescent Hetero-opals,” J. Appl. Phys., vol. 95, p. 1029, 2004; Palacios-Lidón et al., “Optical and Morphological Study of Disorder in Opals,” J. Appl. Phys., vol. 97, p. 63502 2005; Jeong et al., “Some New Developments in the Synthesis, Functionalization, and Utilization of Monodisperse Colloidal Spheres,” Adv. Funct. Mater., vol. 15, pp. 1907-1921, 2005; Kaminaga et al., “Black Spots in a Surfactant-rich Belousov-Zhabotinsky Reaction Dispersed in a Water-in-Oil Microemulsion System,” J. Chem. Phys., vol. 122, p. 174706, 2005; Antal et al., “Formation of Liesegang Patterns A Spinodal Decomposition Scenario,” Phys. Rev. Letters, vol. 83, p. 2880, 1999; and Izsak et al., “A New Universal Law for the Liesegang Pattern Formation.” J. Chem. Phys., vol. 122, p. 184707, 2005; the disclosures of which are incorporated herein by reference in their entireties.

A practitioner of ordinary skill in the art may also find some helpful guidance regarding image processing techniques by examining the following references: Angelsky et al., “Optical Correlation Measurements of the Structure Parameters of Random and Fractal Objects,” Meas. Sci. Technol., vol. 9, pp. 1682-1693, 1998; Jakeman, “Fresnel Scattering by a Corrugated Random Surface with Fractal Slope”; J Opt. Soc. Am., vol. 72, pp. 1034-1041, 1982; Chang et al., “Fully-Phase Asymmetric-Image Verification System Based on Joint Transform Correlator,” Optics Express, vol. 14, 1458-1467, 2006; Welstead, “Fractal and Wavelet Image Compression Techniques,” SPIE Optical Engineering Press, 1999; Barnsley et al., U.S. Pat. No. 4,941,193, entitled “Methods and Apparatus for Image Compression by Iterated Function System” and issued on Jul. 10, 1990; Barnsley et al., U.S. Pat. No. 5,347,600, entitled “Methods and Apparatus for Compression and Decompression of Digital Image Data” and issued on Sep. 13, 1994; and Barnsley et al., U.S. Pat. No. 5,065,447, entitled “Methods and Apparatus for Processing Digital Data” and issued on Nov. 12, 1991; the disclosures of which are incorporated herein by reference in their entireties.

A practitioner of ordinary skill in the art may also find some helpful guidance regarding luminescent materials by examining the following references: Yen et al., “Inorganic Phosphors: Compositions, Preparations and Optical Properties,” CRC Press, 2004; and “Phosphor Handbook,” ed. S. Shionoya and W. M. Yen, CRC Press, 1999; the disclosures of which are incorporated herein by reference in their entireties.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, or process to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

What is claimed is:

1. An object to be authenticated, comprising:
a substrate; and
a marking adjacent to the substrate and including a luminescent material distributed in accordance with a correlated random pattern, the luminescent material exhibiting photoluminescence having a quantum efficiency of at least 10 percent.

2. The object of claim 1, wherein the marking is a security marking to authenticate the object.

3. The object of claim 1, wherein the correlated random pattern is a fractal pattern.

4. The object of claim 1, wherein the correlated random pattern is a pattern related to aperiodic tiling.

5. The object of claim 1, wherein the marking includes domains arranged in accordance with the correlated random pattern, and the luminescent material is distributed within at least a subset of the domains.

6. The object of claim 5, wherein the luminescent material is a first luminescent material, and the marking includes a second luminescent material distributed within at least a subset of the domains.

7. The object of claim 6, wherein the first luminescent material has a first peak emission wavelength, and the second luminescent material has a second peak emission wavelength that is different from the first peak emission wavelength.

8. The object of claim 7, wherein at least one of the first peak emission wavelength and the second peak emission wavelength is in the infrared range.

9. The object of claim 6, wherein the first luminescent material is distributed within a first subset of the domains, and the second luminescent material is distributed within a second subset of the domains.

10. The object of claim 1, wherein the marking includes particles including the luminescent material and the particles are distributed in accordance with the correlated random pattern.

11. The object of claim 10, wherein the particles have sizes in the nanometer range.

12. The object of claim 11, wherein the particles are monodisperse with respect to the sizes of the particles.
